(19) United States
(12) Patent Application Publication
(10) Pub. No.: US 2013/0292969 A1
(43) Pub. Date: Nov. 7, 2013

(54) FRONT END MODULE ARRANGEMENT FOR THE CHASSIS OF A MOTOR VEHICLE

(71) Applicants: Thomas Metzner, Stuttgart (DE); Thorsten Leudts, Osnabruck (DE)

(72) Inventors: Thomas Metzner, Stuttgart (DE); Thorsten Leudts, Osnabruck (DE)

(73) Assignee: FAURECIA KUNSTSTOFFE AUTOMOBILSYSTEME GMBH, GAIMERSHEIM ALLEMAGNE (DE)

(21) Appl. No.: 13/884,498

(22) PCT Filed: Nov. 25, 2011
(86) PCT No.: PCT/EP11/71056

§ 371 Date: Jul. 24, 2013

(30) Foreign Application Priority Data
Nov. 26, 2010 (DE) 10 2010 052 510.3

(51) Int. Cl. B62D 21/15; B62D 25/08

(52) U.S. Cl. CPC B62D 21/15; B62D 25/08
USPC 296/187.09

(57) ABSTRACT

The invention relates to a front end module arrangement for the chassis of a motor vehicle, having a front end module mount (30) comprising at least one mounting element (32), in particular an upper belt, which may be supported on associated mounting elements (38) of the chassis of the motor vehicle via respective energy absorption elements (36), wherein the energy absorption elements (36) are arranged in a corresponding seating (44) of the mounting element (32) of the front end module mount (30) in an integrated manner.

The invention relates to a front end module arrangement for the chassis of a motor vehicle according to the preamble of claim 1. Furthermore, the invention also relates to the chassis of a motor vehicle having such front end module arrangement, as well as an energy absorption element for such front end module arrangement according to the preamble of claim 8.

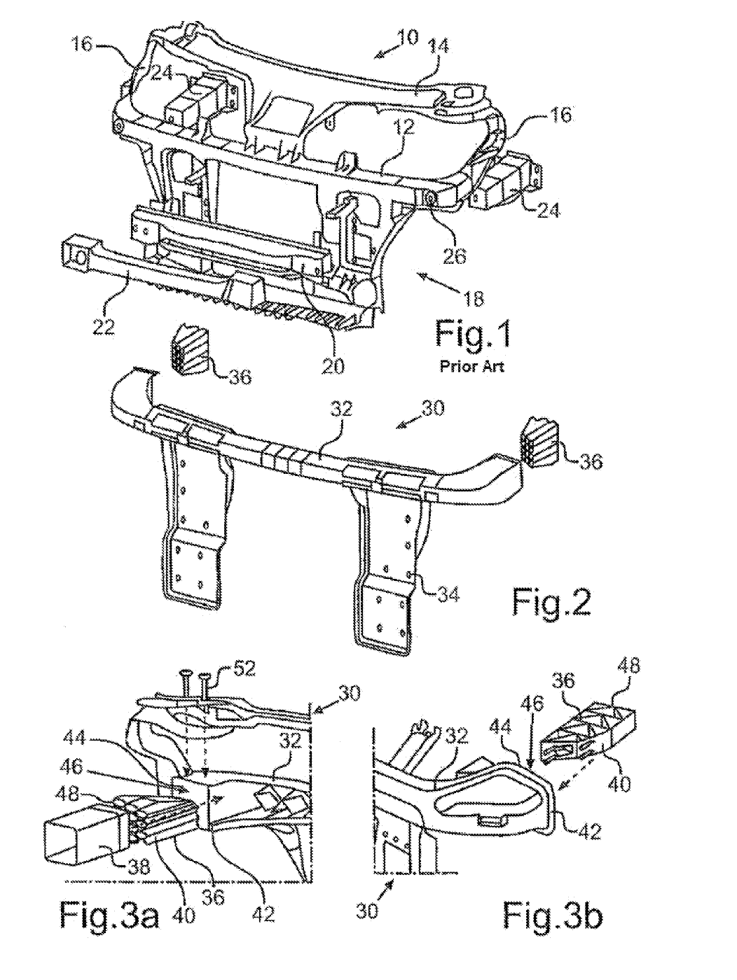

Such front end module arrangement, is already being utilized, for example, in at least one vehicle, and is illustrated in FIG. 1 in a perspective exploded view. In this regard the front end module arrangement shown therein comprises a front end module mount 10, having a mounting element 12 in the form of an upper belt. This mounting element 12, along with an upper mounting element 14, as well as two side parts 16, forms an approximately rectangular, circumferential, closed frame. Toward the bottom, a structure 18 of the front end module mount 10 is connected to the mounting element 12, on which a cross beam 20 having a foam part 22 is supported for the protection of pedestrians.

Also shown are two energy absorption elements 24 in the form of so-called crash boxes, via which the mounting element 12 in the form of an upper belt is supported toward the back on each side. These two energy absorption elements 24 are supported toward the back on not recognizably related mounting elements in the form of longitudinal chassis beams of the motor vehicle. The mounting of the mounting element 12 to the respective energy absorption element 24 is carried out via respective screw joints penetrating the mounting element 12 in the region of a respective through hole 26, and which are connected to the respective energy absorption element 24. For this purpose the respective screw joints extend in the longitudinal vehicle direction, or horizontally, respectively.

The object of the present invention is to create a front end module arrangement for the chassis of a motor vehicle, a chassis for a motor vehicle itself, as well as an energy absorption element for such front end module arrangement of the type mentioned above, by means of which a crush zone may be created, which is particularly favorable for a high weight, has a high energy absorption capacity, and furthermore has a particularly advantageous stiffness.

Said problem is solved according to the invention by means of a front end module arrangement, a chassis, and an energy absorption element having the characteristics of claim 1, 6, or 8, respectively. Advantageous further embodiments with purposeful and non-trivial additional designs of the invention are each stated in the dependent claims.

In order to create a front end module arrangement of the type mentioned above, by means of which an improved crush zone may be realized for the chassis of the motor vehicle, it is provided according to claim 1 that the energy absorption elements are arranged in an integrated manner at least across a length area in a corresponding seating of the mounting element of the front end module mount. For this purpose the seatings of the mounting elements are preferably embodied approximately in the form of a shaft, i.e. as a circumferential closed shaft, for example, such that the respective energy absorption elements are arranged, for example, at least across a predominant length area within the corresponding mounting element of the front end module mount. This results in the particular advantage of significantly reducing the required installation space for the energy absorption elements in the vehicle longitudinal direction. By means of covering the respective mounting element of the front end module mount and the respective energy absorption elements, a respective energy absorption may additionally be achieved in the early phase of an exertion of force due to an accident, by means of which a high degree of impact energy may be absorbed via the front end module arrangement according to the invention. Furthermore, defined loads are relieved without damaging the structure behind.

In a further advantageous embodiment of the invention the energy absorption elements are at least essentially arranged in an integrated manner across their entire length in the corresponding seating of the mounting element of the front end module mount. Such complete integration enables not only a particularly early response of the crush zone and a high energy absorption capacity, but due to this complete integration of the respective energy absorption element the corresponding mounting element may also be connected directly to the respective longitudinal beams of the chassis in a particularly simple manner, which adjoin the respective energy absorption elements. In this manner a particularly rigid connection is achieved between the mounting element of the front end module mount and the respective longitudinal beam of the chassis of the motor vehicle. Furthermore, the respective longitudinal beam of the chassis of the motor vehicle enables a particularly beneficial support of the corresponding energy absorption element, which protrudes completely into the mounting element of the front end module mount.

The advantages described above in the context of the front end module arrangement according to the invention equally apply to the chassis according to patent claim 6. Furthermore, a particularly rigid mounting of the front end module arrangement to the chassis of the motor vehicle may be created, if the mounting element, in particular the upper belt, is connected at their respective rear ends to corresponding A-pillars. In particular with regard to the torsional stiffness, a particularly advantageous structure may be achieved in this manner.

The advantages described above in the context of the front end module arrangement according to the invention, and of the chassis according to the invention also apply to the energy absorption element according to patent claim 8. The same is characterized in particular in that it is made from plastic. Not only is such an embodiment particularly advantageous with regard to weight, but is also particularly easy to produce. Furthermore, the shape of the plastic may simply be constructed such as to create a targeted deformation and energy absorption capacity.

Further advantages, characteristics and details of the invention are obvious from the following description of a preferred exemplary embodiment, as well as from the drawings; they show:

FIG. 1 a perspective exploded view of a front end module arrangement according to prior art;

FIG. 2 a perspective exploded view of a front end module arrangement for the chassis of a motor vehicle according to the invention with a front end module mount essentially having a U-shaped mounting element in the form of an upper belt, which may be supported by means of the mediation of respective energy absorption elements in the form of longitudinal beams of the chassis of the motor vehicle, wherein the energy absorption elements may be arranged essentially completely in the corresponding seatings of the mounting elements of the front end module mount in an integrated manner as circumferentially closed shafts;

FIG. 3a, 3b a perspective exploded view of the lateral back, and a perspective exploded view of the lateral front of the mounting element in the form of the upper belt of the front end module mount, as seen as a section, into the circumferentially closed terminal shaft of which the corresponding energy absorption element may at least essentially be completely inserted, wherein the mounting element may be directly connected to the corresponding longitudinal beam of the chassis of the motor vehicle seen in FIG. 3a with the mediation of respective screw couplings, which extend essentially in the vehicle height direction;

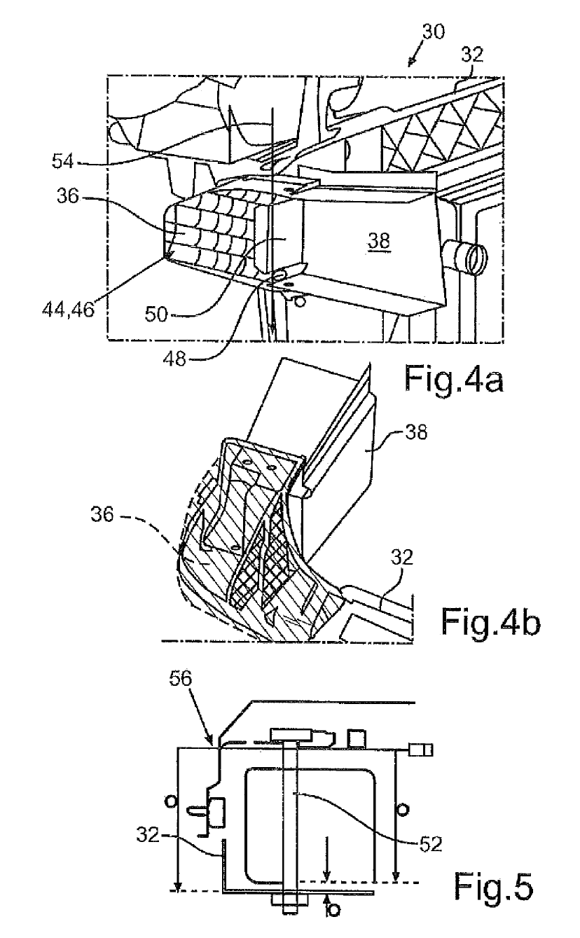

FIG. 4a, 4b a partial sectional view of the front end module arrangement along a sectional plane extending in the vehicle height direction, or in the vehicle longitudinal direction, respectively, wherein particularly the integration of the corresponding energy absorption element into the respective shaft-like seating of the mounting element, as well as the proximate arrangement and mounting of the mounting element on the corresponding longitudinal beam of the chassis of the motor vehicle positioned behind, is shown; and in

FIG. 5 a partial sectional view of the connection of the mounting element, or of the upper belt of the front end module mount, respectively, in the area of the rear end at a corresponding A-pillar of the chassis of the motor vehicle.

While FIG. 1 shows a perspective exploded view of the above explained front end module arrangement according to prior art, FIGS. 2 to 5 show a front end module arrangement according to the invention for a chassis of a motor vehicle, which in the present example is embodied in a one-volume form with only one vehicle seat row. Accordingly, a crush zone is to be achieved in the current case, which has a relatively small installation length in the vehicle longitudinal direction, yet still having a particularly high energy absorption capacity in case of a frontal collision due to an accident.

In this regard FIG. 2 shows a perspective exploded view of a front end module arrangement, which initially comprises a front end module mount 30. This front end module mount 30 has a mounting element 32 as an essential component in the form of an upper belt, the shape of which is explained in further detail below. This mounting element 32 is in the present example embodied e.g. as a hybrid component having one or more metal mounting parts, which has or have been insert-molded with plastic. Of course, other embodiments of this mounting element 32, e.g. made completely of a respectively stable plastic, are also conceivable.

Furthermore, the front end module mount 30 comprises two supports 34 protruding from the mounting element 32 toward the bottom, on which, for example, a cross beam, which is not explained in further detail, or a foam piece, which particularly serves for the protection of a pedestrian, may be supported.

Additionally, two energy absorption elements 36 are shown in the form of so-called crash boxes, via which the mounting element 32 may be supported on corresponding longitudinal beams 38 (FIGS. 3a, 4a, 4b) in a manner described in detail below.

One distinctive feature of the present front end module arrangement is that the two energy absorption elements 36 are made at least partially of plastic 40. Preferably, the two energy absorption elements 36 consist completely of plastic. For this purpose the energy absorption elements 36—as shown in the synopsis of FIGS. 3e and 3b—may have different structures.

In this regard FIG. 3a shows that the energy absorption element 36, illustrated therein has a tubular structure of adjacent tube elements, which may be embodied in one piece or in multiple pieces. In contrast, the energy absorption element 36 shown in FIG. 3b is equipped with a rib structure.

As can be seen in the synopsis of FIGS. 3a and 3b the mounting element 32 has a corresponding seating 44 at each of its respective ends 42 for the associated energy absorption element 36. In the current case these seatings 44 are embodied as circumferentially closed box-shaped shafts 46. The cross-sectional form of the shafts 46, or seatings 44, respectively, may essentially be adjusted to the mounting structure of the mounting element 32. For example, it is conceivable in particular that the mounting element 32 has a continuous hollow structure, or a hollow profile with an alternating or equal cross-section.

As shown in FIGS. 3a and 3b the respective energy absorption element 36 is to be arranged within the corresponding seating 44, or within the respective shaft 46, respectively, at least across a longitudinal area, in the present case, however, at least essentially completely. In other words, the respective energy absorption element 36 may be inserted into the respective end 42 of the mounting element 32, until—as viewed in the insertion direction—each respective rear end 48 of the energy absorption element 36 ends at least approximately at least in an overlapping manner at the respective end 42 of the mounting element 32. For this purpose the mounting element is preferably adjusted to the hollow cross-section of the respective shaft 46 of the seating 44 of the mounting element 32, at least across a longitudinal area.

As shown, in particular, in the synopsis of FIGS. 3a and 4a the complete integration of the respective energy absorption element 36 into the corresponding end 42 of the mounting element 32 provides the possibility that the mounting element 32 may be connected directly to the respective longitudinal beam 38 of the chassis of the motor vehicle, wherein—as shown, in particular, in FIG. 4e—the respective energy absorption element 36 preferably directly adjoins the longitudinal beam 38 at its rear end 48, or is supported on the same at its rear. For this purpose the longitudinal element 38—as shown in FIG. 4a—has a respective journal 50. In case of an exertion of force due to an accident the mounting element 32 may thereby be supported on the respective longitudinal beam 38 positioned behind via the energy absorption elements 36.

Additionally, as shown particularly in FIG. 3a, and from arrow 54 according to FIG. 4a, the respective end 42 of the mounting element 36 is directly connected to the corresponding front end of the respective longitudinal beam 38 via two screw couplings 52, which extend vertically. The mounting of the mounting element 32 to the longitudinal beams 38 is therefore not carried out by means of the mediation of the respective energy absorption elements 36, but rather in a direct manner. Accordingly, the respective rear ends 42 of the mounting element 32 also extend at least up to the rear ends of the energy absorption elements 36. Finally, FIG. 4b again shows the connection of such a rear end 42 of the mounting element 32 at the corresponding front end of the longitudinal beam 38.

The energy absorption elements 36, which in the current case consist of plastic 40, may, in the present exemplary embodiments, be fixed, or clipped in, respectively, in their final position at the mounting element 30 via respective latching elements. With the integration of the energy absorption elements 36 into the mounting element 32 it is clear that the presentability of the force path courses via the upper load plane must be ensured. For this purpose a maximum energy absorption in consideration of the maximum force level of the body shell, or the chassis, respectively, while utilizing the available deformation length, is particularly desired. By integrating the energy absorption elements 36 the installation space required for the same may be reduced significantly. With the invention the energy of the various load sources, such as by means of the crash repair test, may be relieved in a targeted manner.

Finally, FIG. 5 shows in which manner the mounting element 32 may be connected at its respective ends 42 to corresponding A-pillars 56. For this purpose respective longitudinal beams 38 are associated with the A-pillars 56 such that the desired and illustrated screw coupling may be carried out in the vehicle height direction (z-direction). By means of this connection of the front end module, or of the front end module mount 30, respectively, and of the mounting element 32, the torsional stiffness may be significantly improved in the area of the crush zone. This is of particular advantage in the present case, since the mounting element 32, or the upper belt, respectively, must contribute to the torsional stiffness of the body shell, or the chassis, respectively. For this purpose the mounting element 32, or the upper belt, respectively, is accordingly pushed over the corresponding A-pillar 56, and screwed in via the two screw couplings 52, each in the vehicle height direction (z-direction). For this purpose the tolerance concept must be configured such that a module installation is possible using a handling tool. It is particularly advantageous, if all coupling points may be utilized for all variations of the motor vehicle. In this regard the A-pillar 56 offers the possibility for direct referencing.

1. A frontend module arrangement for the chassis of a motor vehicle, having a front end module mount (30) comprising at least one mounting element (32), in particular an upper belt, which may be supported on associated mounting elements (38) of the chassis of the motor vehicle via respective energy absorption elements (36), characterized in that the energy absorption elements (36) are arranged, at least across a length area, in a corresponding seating (44) of the mounting element (32) of the front end module mount (30), in an integrated manner.

2. The frontend module arrangement according to claim 1, characterized in that the energy absorption elements (36) are arranged at least essentially across their entire length in the corresponding seating (44) of the mounting element (32) of the front end module mount (30) in an integrated manner.

3. The frontend module arrangement according to claim 1, characterized in that the respective seating (44) of the mounting element (32) is embodied as a circumferentially closed shaft (46).

4. The frontend module arrangement according to claim 1 characterized in that the mounting element (32), in particular the upper belt, of the front end module mount (30) is directly connected to the respective longitudinal beams (38) of the chassis, wherein the respective energy absorption elements (36) adjoin the longitudinal beams (38).

5. The frontend module arrangement according to claim 1, characterized in that that the respective rear ends (42) of the mounting element (38), in particular the upper belt, of the front end module mount (30) extend at least up to the rear ends (48) of the energy absorption elements (36).

6. A chassis of a motor vehicle, having a front end module arrangement according to claim 1.

7. The chassis according to claim 6, characterized in that the mounting element (32), in particular the upper belt, is connected to respective rear ends (42) of the mounting element (38) via corresponding A-pillars (56).

8. An energy absorption element (36) for a frontend module arrangement for the chassis of a motor vehicle, by means of which a mounting element (32), in particular an upper belt, of a front end module mount (30) may be supported on associated mounting elements (38) on the chassis of the motor vehicle, characterized in that the energy absorption element (36) is made from plastic (40).

9. The frontend module arrangement according to claim 2, characterized in that the mounting element (32), in particular the upper belt, of the front end module mount (30) is directly connected to the respective longitudinal beams (38) of the chassis, wherein the respective energy absorption elements (36) adjoin the longitudinal beams (38).

10. The frontend module arrangement according to claim 3, characterized in that the mounting element (32), in particular the upper belt, of the front end module mount (30) is directly connected to the respective longitudinal beams (38) of the chassis, wherein the respective energy absorption elements (36) adjoin the longitudinal beams (38).
